(19) United States
(12) Patent Application Publication
(10) Pub. No.: US 2006/0120235 A1
(43) Pub. Date: Jun. 8, 2006

(54) System and method of erasing non-volatile recording media

(75) Inventor: Peter Jensen, Fremont, CA (US)

Correspondence Address: GREENBERG TRAURIG LLP, 2450 COLORADO AVENUE, SUITE 400E, SANTA MONICA, CA, 90404, US

(73) Assignee: TEAC Aerospace Technologies

(21) Appl. No.: 11/006,120

(22) Filed: Dec. 6, 2004

(51) Int. Cl. G11B 5/09

(52) U.S. Cl. 369/47.1

(57) ABSTRACT

A method and system for the erasing of data from a non-volatile recording medium includes a non-volatile recording medium controller, a non-volatile recording medium, and a CPU. A data pattern used in an erasure command is sent to the non-volatile recording medium a single time. Consequently, the amount of data transferred to the non-volatile recording medium controller is reduced to a minimum. After receiving the erasure command, the non-volatile recording medium controller overwrites an erasure area with the data pattern.

### BACKGROUND OF THE DISCLOSURE

1. Field of the Disclosure

The disclosure relates to secure and efficient erasure of data. In particular, the disclosure relates to erasure of data that is stored on a recording medium.

2. General Background

Many electronic systems rely on non-volatile recording media to store data. The non-volatile recording medium can be a hard drive, solid state flash drive, PCMCIA card, PC card, magnetic tape, or optical storage medium. Other types of non-volatile recording media can also be used. A complete and secure erasure methodology is utilized in high security systems such as those used in the military to ensure that data once stored in non-volatile recording media can never be recovered. Further, lower level security systems can utilize complete erasure to protect personal or confidential data.

One current method for erasing data is deleting the pointer that points to the target data to be erased. Although the data is inaccessible through the deleted pointer, the data remains recorded in memory and is potentially accessible through other means. The erased data can potentially be revived if, for example, the non-volatile recording medium is entirely parsed out memory location by memory location. Accordingly, solely erasing the pointer does not securely erase the data from the non-volatile recording medium.

Overwriting the erasure area in its entirety is helpful in providing a complete erasure. To overwrite the erasure area entirely, the memory locations in the erasure area are recorded with a predetermined data pattem. Thus, the data originally recorded in the erasure area is overwritten. A data pattern can include a variety of digits and/or alphanumeric characters. For instance, the data pattern can include a series of ones, zeroes, or a random combination of ones and zeroes.

Generally, if an erasure procedure uses only one data pattern, the erasure procedure may leave traces of the value previously stored in a particular memory location. Although these traces are not easily read, the traces can be read by using extraordinary measures.

### SUMMARY

In one aspect, there is a method of securely erasing data from a non-volatile recording medium. An erasure area identifier is transmitted from a processor in a computing device to a non-volatile recording medium controller. The erasure area identifier corresponds to a plurality of memory locations in an erasure area in the non-volatile recording medium. The non-volatile recording medium controller is operably connected with the non-volatile recording medium. A data pattern is also transmitted from the processor in the computing device to the non-volatile recording medium controller. The data pattern is transmitted in a single transfer. Finally, an erasure command is transmitted from the processor in the computing device to the non-volatile recording medium controller. The non-volatile recording medium controller constructs a plurality of instructions to overwrite the plurality of memory locations in the erasure area identified by the erasure area identifier. Each of the instructions writes at least one of the memory locations in the erasure area identified by the erasure area identifier with the data pattern.

In another aspect, the erasure area identifier is randomly generated. In another aspect, the erasure area identifier is inputted by the user. In another aspect, the erasure area identifier includes a start memory location in the erasure area and a memory location count. In another aspect, the erasure area identifier defines the erasure area according to a cylinder-head-sector addressing scheme. In yet another aspect, the erasure area identifier defines the erasure area according to a logical block addressing scheme.

In one aspect, the erasure area identifier or the data pattern are pre-stored in a storage device, the storage device coupled with the processor in the computing device. In another aspect, the data pattern is randomly generated or inputted by the user. In another aspect, the processor in the computing device a signal indicative of a status of the data in the erasure area of the non-volatile recording medium.

In another aspect, the non-volatile recording medium is a hard disk. In another aspect, the non-volatile recording medium is a solid-state PROM memory. In another aspect, the non-volatile recording medium is a solid-state flash memory. In another aspect, the non-volatile recording medium is a magnetic tape.

In one aspect there is a method of securely erasing data from a non-volatile recording medium. An erasure command is transmitted from a processor in a computing device to a non-volatile recording medium controller. The non-volatile recording medium controller is operably connected with the non-volatile recording medium. A plurality of instructions are constructed to overwrite a plurality of memory locations corresponding to an erasure area identified by a pre-stored erasure area identifier. Each of the instructions writes at least one of the memory locations in the erasure area identified by the pre-stored erasure area identifier with a pre-stored data pattern. The erasure area or the data pattern are pre-stored in the non-volatile recording medium.

In one aspect, there is a method of securely erasing data from a non-volatile recording medium. A erasure area identifier is transmitted from a processor in a computing device to a non-volatile recording medium controller, wherein the erasure area identifier corresponds to a plurality of memory locations in the erasure area in the non-volatile recording medium, and wherein the non-volatile recording medium controller is operably connected with the non-volatile recording medium. A data pattern is transmitted from the processor in the computing device to the non-volatile recording medium controller, wherein the data pattern is being transmitted a number of times which is less than the number of memory locations in the plurality of memory locations in the erasure area. Also, an erasure command is transmitted from the processor in the computing device to the non-volatile recording medium controller, the non-volatile recording medium controller constructing a plurality of instructions to overwrite the plurality of memory locations in the erasure area identified by the erasure area identifier, each of the instructions writing at least one of the memory locations in the erasure area identified by the erasure area identifier with the data pattern.

In one aspect, there is a non-volatile recording medium erasure system. There is a processor in a computing device that transmits an erasure area identifier, a data pattern and an erasure command. The erasure area identifier corresponds to a plurality of memory locations in the erasure area in the non-volatile recording medium. There is a non-volatile recording medium controller that receives transmissions from the processor in the computing device. The non-volatile recording medium controller is operably connected with the non-volatile recording medium, and constructs a plurality of instructions to overwrite the plurality of memory locations in the erasure area identified by the erasure area identifier. Each of the instructions writing at least one of the memory locations in the erasure area identified by the erasure area identifier with the data pattern.

In another aspect, the data pattern can being transmitted a single time or a number of times which is less than the number of memory locations in the plurality of memory locations in the erasure area. In another aspect, if the erasure area identifier is zero, all memory locations in the non-volatile recording medium are written with the data pattern.

In one aspect, there is a method of securely erasing data from a non-volatile recording medium. A data pattern and an erasure area identifier are transmitted from a processor in a computing device to a non-volatile recording medium controller in a single transfer. The erasure area identifier corresponds to a plurality of memory locations in the erasure area in the non-volatile recording medium. The non-volatile recording medium controller is operably connected with the non-volatile recording medium. An erasure command is transmitted from the processor in the computing device to the non-volatile recording medium controller. The non-volatile recording medium controller constructing a plurality of instructions to overwrite the plurality of memory locations in the erasure area identified by the erasure area identifier. Each of the instructions writing at least one of the memory locations in the erasure area identified by the erasure area identifier with the data pattern.

### BRIEF DESCRIPTION OF THE DRAWINGS

By way of example, reference will now be made to the accompanying drawings.

FIG. 1A illustrates a computing system for securely erasing data stored in a non-volatile recording medium.

FIG. 1B illustrates a computing system wherein the non-volatile recording medium is a hard disk drive.

FIG. 2A illustrates a tabular diagram of the content of an erasure message sent to a hard drive with cylinder-head-sector addressing.

FIG. 2B illustrates a tabular diagram of the content of an erasure message sent to a hard drive with logical block addressing.

FIG. 3 illustrates a flow diagram of a non-volatile recording medium erasure.

### DETAILED DESCRIPTION

The method and system described below provide faster erasure of data stored on non-volatile recording media than previously seen. Normally, erasure of data on a non-volatile recording medium involves the use of a data pattern. The data pattern is usually sent to the non-volatile recording medium every time a memory location is overwritten. As a consequence, a large number of transfers of the data pattern is usually required because a secure erase generally involves overwriting thousands, if not millions, of memory locations on the non-volatile recording medium. The transfer of each data pattern to the non-volatile recording medium requires a significant amount of time. The method and system described below reduces the amount of time needed to perform a secure erasure by reducing the number of transfers of the data pattern to the non-volatile recording medium.

It will be apparent to one skilled in the art that this erasure method can be applied to multiple types of non-volatile recording media including optical, magnetic and solid state recording media. These and other features will be discussed below.

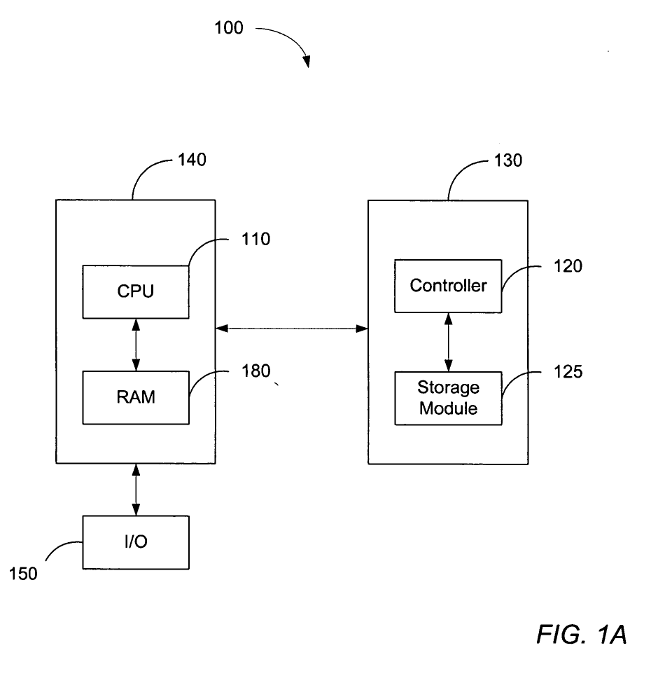

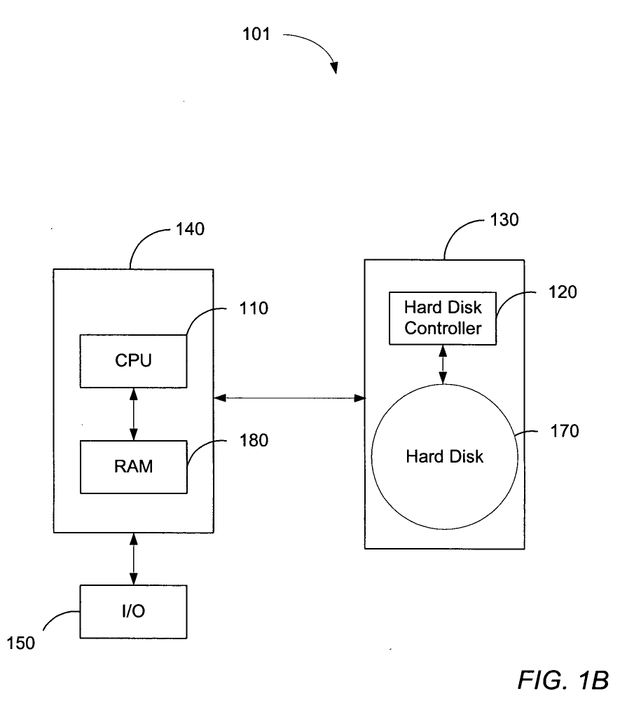

FIG. 1A illustrates a computing system 100 for securely erasing data stored in a non-volatile recording medium 130. In one embodiment, the non-volatile recording medium 130 includes a controller 120 and a storage module 125. The controller 120 can be a computer processor that stores data in the storage module 125 by directing the reading and writing of data on the storage module 125. The controller 120 communicates with external devices such as a computing device 140. The computing device 140 communicates with the controller 120 to manage the data that is written and erased from the storage module 125. The computing device 140 includes a CPU 110 and a random access memory (“RAM”) 180. The CPU 110 manages the RAM memory 180. The computing device 140 may receive user input through an input/output device 150. The input/output device 150 can be a keyboard, a mouse, a touchpad, a joystick, a touch-screen, a voice recognition system, etc. The computing device 140 can be a personal computer, a laptop, a cellular phone, a personal data assistant, a media player, a media recorder, a server, a digital video recorder, an embedded control system in a media recorder, an embedded control system in a digital video recorder, an embedded control system in any other electrical device, etc.

In one embodiment, a user enters an erasure command to erase specific data from the storage module 125. The computing device 140 receives the erasure command entered by the user through the input/output device 150. The input/output device 150 then provides the erasure command entered by the user to the CPU 110. In another embodiment, the erasure command is triggered or generated by the CPU 110.

The CPU 110 communicates with the controller 120 by transmitting and receiving various commands in relation to the data to be stored in the storage module 125. One such message that is sent from the CPU 110 to the controller 120 is an erasure message.

The erasure message can include an erasure command, a data pattern, and an erasure area identifier. In one embodiment, the CPU 110 generates the data pattern. In another embodiment, the data pattern is randomly generated from a random number generator. In one embodiment, the CPU 110 has a random number generator. In yet another embodiment, the user inputs the data pattern.

The erasure area identifier specifies a collection of memory locations in the storage module 125 where the data to be erased resides. The erasure area identifier is either inputted by the user or generated by the CPU 110. In one embodiment, a user may input the name of a file to be deleted. Based on the name inputted by the user, the CPU 110 can search the corresponding address of the file in the non-volatile recording medium. The CPU 110 can then generate the erasure area identifier based on the size of the file and the starting address in the non-volatile recording medium.

In yet another embodiment, an application running on the computer device 140 may require a file to be deleted, and the CPU 110 generates the erasure area identifier based on the address of the file in the non-volatile recording medium. In yet another embodiment, the user specifies the erasure area identifier through the input/output device 150.

The erasure area identifier may define the erasure area in various manners. In one embodiment, the erasure area identifier can be a list of memory locations. In another embodiment, the erasure area identifier can be a starting memory location and an ending memory location. In another embodiment, the erasure area identifier can be a starting memory location and a memory location count. In another embodiment, the erasure area identifier can be a flag which indicates that all the writeable locations on the storage module 125 are to be written with the data pattern.

In one embodiment, the erasure message is transmitted a single time from the CPU 110 to the controller 120. After the controller 120 receives the message, the controller 120 writes the data pattern to the memory locations in the storage module 125 that correspond to the erasure area identifier.

For example, in a situation where a secure erasure requires complete erasure of a non-volatile recording medium with a capacity of sixty (60) gigabytes, the data pattern would normally have to be transferred to the non-volatile recording medium sixty billion times. If the data pattern is only transferred once, the transfer time becomes negligible. The total erasure time is then reduced to the amount of time it takes to write the data in the non-volatile recording medium. In this particular example, the total erasure time is reduced by fifteen minutes. Furthermore, in this example, fifteen minutes would be saved for each additional data pattern used. Thus, if a secure erase requires three data patterns to be used as part of the erasure, 0×55, 0×AA, 0×FF, the total time saved would be forty-five minutes.

In yet another embodiment, the CPU 110 sends multiple erasure messages to the controller 120. In one embodiment, all erasure messages contain the same data pattern but different erasure area identifiers. Thus, the number of erasure messages is less than the number of total memory locations to be overwritten. For example, the controller 120 receives a first erasure message with a first erasure area identifier and a first data pattern. The controller 120 starts writing the first data pattern on the memory locations of the storage module 120 specified by the first erasure area identifier. Subsequently, the controller 120 receives a second message with a second erasure area and the first data pattern. The number of messages sent to the controller is less than the sum of the number of memory locations in the erasure area of the storage module 125 specified by the erasure area identifier. Therefore, the total transfer time is reduced because not every memory location requires a transfer.

In an alternative embodiment, multiple erasure messages can contain the same erasure area identifier but different data patterns. For instance, a first erasure message can overwrite a rage of memory locations with a first data pattern while a second erasure message can erase the same set of memory locations with a second data pattern to ensure a secure erasure with multiple data patterns. In another embodiment, the first erasure message can overwrite a first range of memory locations, with the first data pattern, and the second erasure message can overwrite a second range of memory locations with the second data pattern.

When multiple erasure messages are sent to the controller 120, the controller 120 can write to multiple locations at a time. In one embodiment, the controller 120 starts writing the second erasure area before the first erasure command is completed. As a result of the controller 120 simultaneously writing to multiple memory locations of the storage module 125, the time needed to overwrite the data stored in the memory locations is further reduced.

In one embodiment, the erasure message does not contain a data pattern. The data pattern can be pre-stored in the storage module 125. Thus, after receiving the erasure message, the controller 120 acquires the data pattern by retrieving the data pattern from the storage module 125. In another embodiment, the storage module stores a collection of data patterns to be retrieved by the controller 120. In another embodiment, the data pattern is hardwired on the controller 120.

In one embodiment, the erasure message does not contain the erasure area identifier because the erasure area identifier is pre-stored in the storage module 125. The controller 120 acquires the erasure area identifier by retrieving the erasure area from the storage module 125. In another embodiment, the erasure area identifier is hardwired on the controller 120.

FIG. 1B illustrates a computing system 101 wherein the non-volatile recording medium is a hard disk drive 130. The computing system 101 includes the computing device 110 which communicates with the hard disk drive 130 by sending and receiving commands related to data storage. The hard disk drive 130 includes a hard disk controller 120 that operates the write and read commands on the hard disk 170.

In one embodiment, after the erasure message is constructed in the CPU 110, the erasure message is then transmitted to the hard disk controller 120 in the hard disk drive 130. The hard disk controller 120 parses the erasure message and identifies the parameters contained in the erasure message such as the erasure command, the data pattern, and the erasure area identifier.

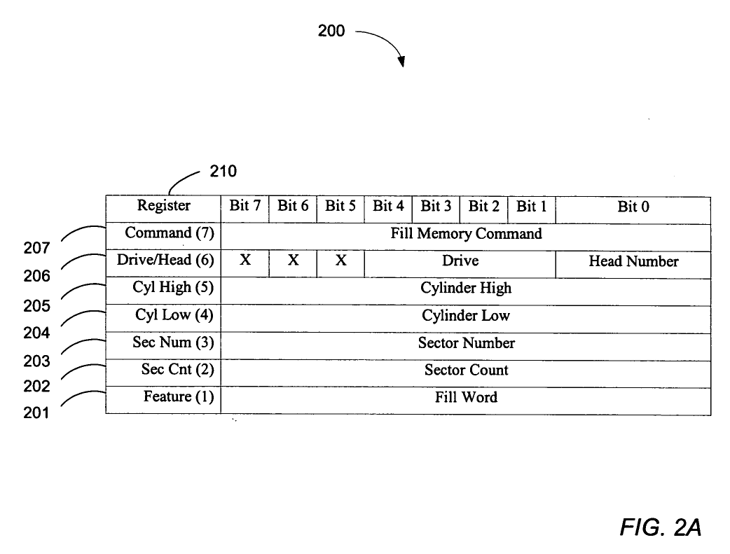

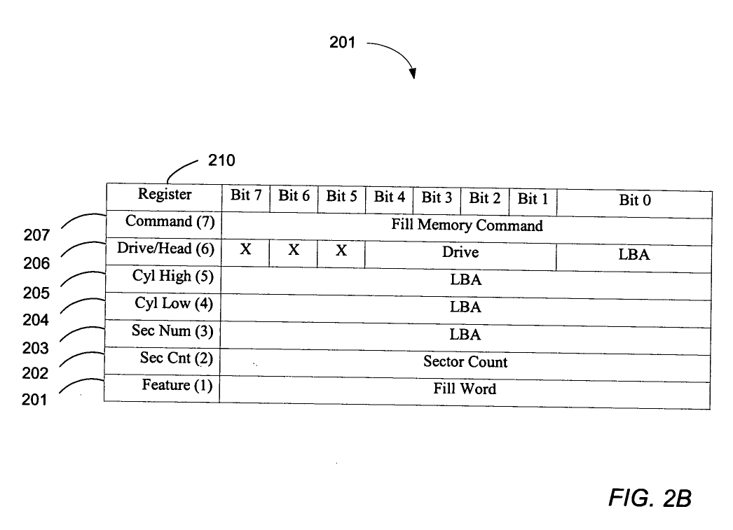

FIG. 2A illustrates a tabular diagram 200 of the content of an erasure message sent to a non-volatile recording medium which has cylinder-head-sector (“CHS”) addressing. In one embodiment, the erasure message illustrated by the tabular diagram 200 is used to write data to the erasure area of the hard disk 170. In another embodiment, the erasure message 200 is used to write data to the erasure area of a non-volatile recording medium with a logical memory structure similar to that of the hard disk 170.

The erasure message contains an erasure command, an erasure area identifier, and a data pattern. In one embodiment, the erasure message utilizes seven registers. In another embodiment, the command register 207 contains a “Fill” command. The name of the “Fill” command suggests that the erasure area is to be “filled” with the data pattern contained in the feature register 201. It will be apparent to one skilled in the art, that the name of the command may have many other variations such as Erase, SecureErase, Delete, SecureDelete, etc.

As illustrated in FIG. 2A, the erasure area identifier can be stored in registers 202 through 206. In one embodiment, registers 202 through 206 contain a starting address and a sector count. The starting address can be defined by a combination of a cylinder number, a head number and a sector number. The head number is stored in register 206 containing the drive information in bits 1-4, and containing the head information in bit 0. The cylinder information is contained in a cylinder high register 205 for a cylinder high parameter; a cylinder low register 204 for a cylinder low parameter. The cylinder number uses one or both registers depending on the length of the cylinder. A sector number register 203 indicates the first sector for writing. In one embodiment, the sector count register 202 indicates the number of sectors to be written with the same data pattern. In another embodiment, if the sector count is zero then the entire non-volatile recording medium is written with the data pattern. In another embodiment, if the sector count is the total number of sectors in the non-volatile recording medium, then the entire non-volatile recording medium is written with the data pattern. The data pattern is contained in the feature register 201.

FIG. 2B illustrates a tabular diagram 201 of the content of an erasure message sent to a non-volatile recording medium that has logical block addressing (“LBA”). In one embodiment, the erasure message illustrated by the tabular diagram 200 is used to write data to the erasure area of the hard disk 170 (FIG. 1B). In another embodiment, the erasure message 201 is used to write data to the erasure area of a non-volatile recording medium with a logical memory structure similar to that of a hard disk 170 (FIG. 1B).

The erasure area identifier can be stored in registers 202 to 206. In one embodiment, the starting address is defined by a sector number stored in one of the registers of the erasure message. In another embodiment, the starting address is stored in multiple registers of the erasure message. In particular, bit 0 in the driver/head register 206, cylinder high register 205, cylinder low register 204, and sector number register 203, are registers used to store the LBA address at which the erasure area starts. The LBA address may be large enough to use some or all of these registers.

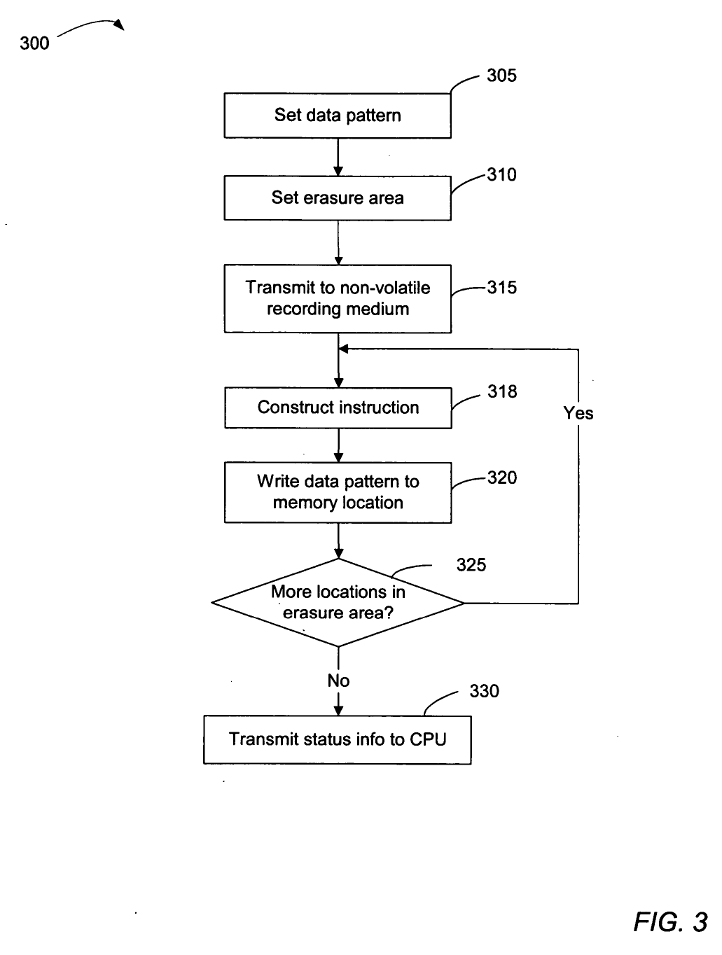

FIG. 3 illustrates a process 300 of erasing data from non-volatile recording medium. In a process block 305, the data pattern is set. The data pattern can be set by user input, computer random generation, computer calculation, etc. Further, at a process block 310, the erasure area identifier is set. Next, at a process block 315, the set erasure area identifier, the set data pattern, and an erasure command are transmitted to the non-volatile recording medium. In one embodiment, the data pattern, the erasure command and the erasure area identifier are transmitted to a hard disk drive controller. In another embodiment, the data pattern, the erasure command and the erasure area identifier are transmitted to a flash memory controller. In another embodiment, all three components can be transmitted together in a single erasure message. In yet another embodiment, a subcombination of the three components can be transmitted in a single erasure message.

After the data pattern, the erasure command and the erasure area identifier have been received, a construction instruction is performed at process block 318. The construction instruction creates a write instruction that includes the memory address to be overwritten, the data pattern used, and a write command. Subsequently, at a process block 320, the write instruction is interpreted and the data pattern is written to the memory location indicated by the write instruction.

After the first write, at a decision block 325, logic is utilized to decide whether to continue writing or not. To accomplish this, the erasure area identifier is examined to determine whether there are remaining locations in the erasure area to write the data pattern. If there are remaining locations in the erasure area, another write instruction is constructed by process block 318 and executed by process block 320. After the write instruction is executed at process block 320, the erasure area identifier is examined again at decision block 325 to determine whether there are any more locations to write the data pattern. If so, another write instruction is constructed and execute on the next memory location, and so on.

Determining that all of the memory locations in the erasure area have been exhausted can be achieved in different ways. In one embodiment, a counter may be used and initialized with a value equivalent to the memory location count value. The counter can then be decreased every time a memory location is written with the data pattern. If the counter value is zero, then there are no more memory locations to be written over. In another embodiment, the counter can be initialized with a value of zero, and increased by a value of one every time a memory location is written with the data pattern. If the counter value is equivalent to the number of memory locations in the erasure area then there are no more memory locations to be written over.

Once all memory locations have been written over, a status signal can be sent at process block 330 from the non-volatile recording medium indicating that the secure erase has been successful. In one embodiment, the CPU receives the status signal.

If another erasure is desired, the method 300 starts over from the beginning. A data pattern is set at process block 305, an erasure area identifier is set at process block 310, and then the data pattern, the erasure area identifier and the erasure command are transmitted at process block 315 to the non-volatile recording medium. Subsequently, all the write instructions are constructed at process block 318 and the memory locations in the erasure area are written over at process block 320. If a third erasure is desired, the method 300 starts over again, and so on.

In one embodiment, a user may decide to complete another erasure on the non-volatile recording medium. The user can choose the number and the sequence of erasure messages. For example, a user may choose to send four subsequent erasure messages to the hard disk controller 120 as part of a secure erase procedure. Common data patterns that are written consecutively to a hard disk or another non-volatile recording medium are the hexadecimal values 0×55, 0×AA, 0×FF, and 0×00. By consecutively writing different binary data patterns to the same memory location, any traces of the original file data values are obliterated. In another embodiment, a computing device may logically calculate that another erasure is necessary and start method 300 again. The computing device can have the hexadecimal values stored in memory and use them randomly when issuing a new erasure in the non-volatile recording medium.

While the above description contains many specifics, these should not be construed as limitations on the scope of the disclosure, but rather as an exemplification of preferred embodiments thereof. The disclosure includes any combination or subcombination of the elements from the different species and/or embodiments disclosed herein. One skilled in the art will recognize that these features, and thus the scope of this disclosure, should be interpreted in light of the following claims and any equivalents thereto.

I claim:

1. A method of securely erasing data from a non-volatile recording medium, comprising:
transmitting an erasure area identifier from a processor in a computing device to a non-volatile recording medium controller, wherein the erasure area identifier corresponds to a plurality of memory locations in an erasure area in the non-volatile recording medium, and wherein the non-volatile recording medium controller is operably connected with the non-volatile recording medium;
transmitting a data pattern from the processor in the computing device to the non-volatile recording medium controller in a single transfer; and
transmitting an erasure command from the processor in the computing device to the non-volatile recording medium controller, the non-volatile recording medium controller constructing a plurality of instructions to overwrite the plurality of memory locations in the erasure area identified by the erasure area identifier, each of the instructions writing at least one of the memory locations in the erasure area identified by the erasure area identifier with the data pattern.

2. The method of claim 1, wherein the erasure area identifier is randomly generated.

3. The method of claim 1, wherein the erasure area identifier is inputted by the user.

4. The method of claim 1, wherein the erasure area identifier includes a start memory location in the erasure area and a memory location count.

5. The method of claim 1, wherein the erasure area identifier defines the erasure area according to a cylinder-head-sector addressing scheme.

6. The method of claim 1, wherein the erasure area identifier defines the erasure area according to a logical block addressing scheme.

7. The method of claim 1, wherein the erasure area identifier is pre-stored in a storage device, the storage device coupled with the processor in the computing device.

8. The method of claim 1, wherein the data pattern is randomly generated.

9. The method of claim 1, wherein the data pattern is inputted by the user.

10. The method of claim 1, wherein the data pattern is pre-stored in a storage device, the storage device coupled with the processor in the computing device.

11. The method of claim 1, wherein the non-volatile recording medium is a hard disk.

12. The method of claim 1, wherein the non-volatile recording medium is a solid state PROM memory.

13. The method of claim 1, wherein the non-volatile recording medium is a solid state flash memory.

14. The method of claim 1, wherein the non-volatile recording medium is a magnetic tape.

15. The method of claim 1, wherein the non-volatile recording medium and the non-volatile recording medium controller are enclosed by a housing.

16. The method of claim 1, further comprising the step of transmitting to the processor in the computing device a signal indicative of a status of the data in the erasure area of the non-volatile recording medium.

17. A method of securely erasing data from a non-volatile recording medium, comprising:
transmitting an erasure command from a processor in a computing device to a non-volatile recording medium controller, wherein the non-volatile recording medium controller is operably connected with the non-volatile recording medium; and,
constructing a plurality of instructions to overwrite a plurality of memory locations corresponding to an erasure area identified by a pre-stored erasure area identifier, each of the instructions writing at least one of the memory locations in the erasure area identified by the pre-stored erasure area identifier with a pre-stored data pattern.

18. The method of claim 17, wherein the erasure area is pre-stored in the non-volatile recording medium.

19. The method of claim 17, wherein the data pattern is pre-stored in the non-volatile recording medium.

20. A method of securely erasing data from a non-volatile recording medium, comprising:
transmitting an erasure area identifier from a processor in a computing device to a non-volatile recording medium controller, wherein the erasure area identifier corresponds to a plurality of memory locations in the erasure area in the non-volatile recording medium, and wherein the non-volatile recording medium controller is operably connected with the non-volatile recording medium;
transmitting a data pattern from the processor in the computing device to the non-volatile recording medium controller, wherein the data pattern is being transmitted a number of times which is less than the number of memory locations in the plurality of memory locations in the erasure area; and
transmitting an erasure command from the processor in the computing device to the non-volatile recording medium controller, the non-volatile recording medium controller constructing a plurality of instructions to overwrite the plurality of memory locations in the erasure area identified by the erasure area identifier, each of the instructions writing at least one of the memory locations in the erasure area identified by the erasure area identifier with the data pattern.

21. A non-volatile recording medium erasure system, comprising:
a processor in a computing device, wherein the processor in the computing device transmits an erasure area identifier, a data pattern and an erasure command, wherein the erasure area identifier corresponds to a plurality of memory locations in the erasure area in the non-volatile recording medium; and
a non-volatile recording medium controller, wherein the non-volatile recording medium controller receives transmissions from the processor in the computing device; wherein the non-volatile recording medium controller is operably connected with the non-volatile recording medium; wherein the non-volatile recording medium controller constructs a plurality of instructions to overwrite the plurality of memory locations in the erasure area identified by the erasure area identifier, each of the instructions writing at least one of the memory locations in the erasure area identified by the erasure area identifier with the data pattern.

22. The system of claim 21, wherein the data pattern is being transmitted a single time.

23. The system of claim 21, wherein the data pattern is being transmitted a number of times which is less than the number of memory locations in the plurality of memory locations in the erasure area.

24. The system of claim 21, wherein if the erasure area identifier is zero, all memory locations in the non-volatile recording medium are written with the data pattern.

25. A method of securely erasing data from a non-volatile recording medium, comprising:
transmitting a data pattern and an erasure area identifier from a processor in a computing device to a non-volatile recording medium controller in a single transfer, wherein the erasure area identifier corresponds to a plurality of memory locations in the erasure area in the non-volatile recording medium, and wherein the non-volatile recording medium controller is operably connected with the non-volatile recording medium; and
transmitting an erasure command from the processor in the computing device to the non-volatile recording medium controller, the non-volatile recording medium controller constructing a plurality of instructions to overwrite the plurality of memory locations in the erasure area identified by the erasure area identifier, each of the instructions writing at least one of the memory locations in the erasure area identified by the erasure area identifier with the data pattern.
